(19) United States
(12) Patent Application Publication
(10) Pub. No.: US 2026/0246795 A1
(43) Pub. Date: Aug. 20, 2026

(54) DETECTION OF LATERAL MOVEMENT IN COMPUTER NETWORKS

(71) Applicant: CrowdStrike, Inc., Sunnyvale, CA (US)

(72) Inventors: Brenden Bishop, San Marcos, CA (US); Yaron Zinar, Petah Tikva (IL); Michael Brautbar, Groton, MA (US)

(21) Appl. No.: 19/058,534

(22) Filed: Feb. 20, 2025

(51) Int. Cl. H04L 9/40; G06N 5/04

(52) U.S. Cl. CPC H04L 63/1425; G06N 5/04; H04L 63/08; H04L 63/10; H04L 63/1441

(57) ABSTRACT

The present disclosure provides an approach of obtaining a request to access a resource in a computer network. The approach provides the request as an input to an artificial intelligence (AI) model, which is trained to produce an inference value that indicates whether the request corresponds to a lateral movement through the computer network. The approach then determines, from the inference value, whether to allow access to the resource, and grants access to the resource based on determining.

### TECHNICAL FIELD

Aspects of the present disclosure relate to cybersecurity, and more particularly, to detecting lateral movement in a computer network using an artificial intelligence (AI) model trained through supervised machine learning.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, insider threats, insider attacks, and hacking attempts aimed at exploiting vulnerabilities in software or hardware. Additionally, cybersecurity threats also encompass suspicious activities, such as unusual patterns of network traffic or unauthorized access attempts, which may indicate potential security breaches or weaknesses that need investigation and mitigation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for producing and using a heuristically enriched labeled dataset to train an AI model, in accordance with some embodiments of the present disclosure.

FIG. 2 is a block diagram that illustrates an example contextual data labeling pipeline, in accordance with some embodiments of the present disclosure.

FIG. 3A is a diagram that illustrates an example table of server access event authentication data, in accordance with some embodiments of the present disclosure.

FIG. 3B is a diagram that illustrates an example table that includes endpoint detection data, in accordance with some embodiments of the present disclosure.

FIG. 3C is a diagram that illustrates an example of a labeled dataset, in accordance with some embodiments of the present disclosure.

FIG. 4A is a flow diagram of a method 400 for generating a labeled dataset and training an AI model via supervised learning using the labeled dataset, in accordance with some embodiments of the present disclosure.

FIG. 4B is a flow diagram of a method 450 for using a trained AI model to detect lateral movement in a computer network, in accordance with some embodiments of the present disclosure.

FIG. 5A is a block diagram that illustrates an example system for lateral movement detection training of an AI model using a labeled dataset, in accordance with some embodiments of the present disclosure.

FIG. 5B is a block diagram that illustrates an example system for using a trained AI model to detect lateral movement in a computer network, in accordance with some embodiments of the present disclosure.

FIG. 6 is a block diagram of an example computing device that may perform one or more of the operations described herein, in accordance with some embodiments of the present disclosure.

### DETAILED DESCRIPTION

Lateral movement in cybersecurity refers to techniques used by threat actors (TAs) to navigate through a network, escalating privileges and accessing sensitive systems by exploiting valid credentials and vulnerabilities. Lateral movement often involves blending malicious activities with normal network operations, requiring advanced monitoring to identify anomalies.

Detecting lateral movements in computer networks is challenging for several reasons. Threat actors often use legitimate credentials to move laterally through the computer network, making their activities appear normal and authorized and therefore making it difficult to distinguish between malicious and regular user behavior. Moreover, enterprise networks are large and complex, with numerous users, devices, and permissions. This complexity creates a vast amount of data, making it challenging to identify abnormal patterns indicative of lateral movement. Likewise, networks are also dynamic, with constant changes in user roles, permissions, and access patterns. This variability may mask malicious activities as normal, especially when organizations do not regularly update their security baselines.

A challenge found in enhancing lateral movement detection through supervised machine learning is the scarcity of labeled data, which is essential for effective supervised learning. Conventional detection methods often rely on anomaly detection, which can produce high false-positive rates due to the lack of labeled data. Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

The present disclosure addresses the challenge above by employing a heuristic data labeling approach to correlate server access authentication data with endpoint detection data to create labeled data for training an AI model through supervised learning. In turn, the present disclosure uses the trained AI model to detect lateral movement more accurately within computer networks.

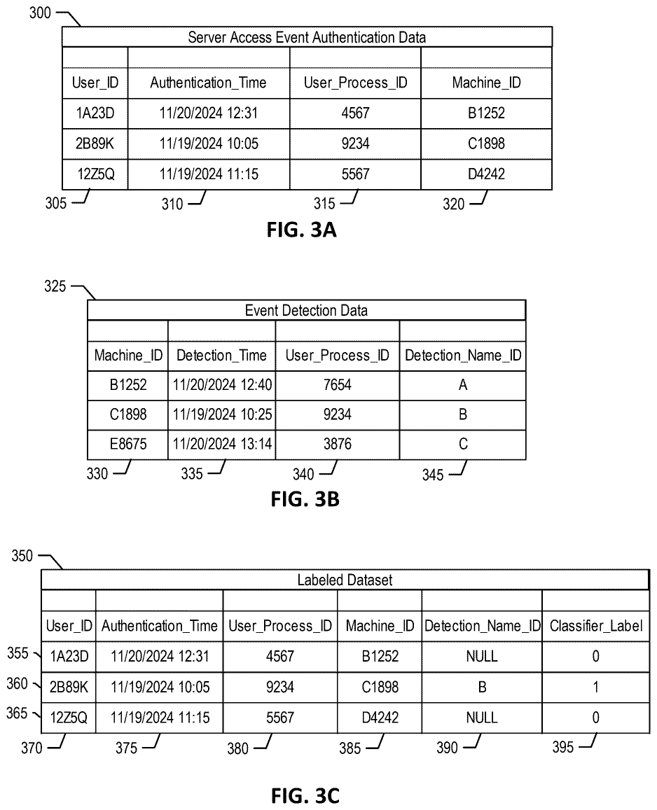

Server access authentication data refers to the records of interactions between users or systems and a server, capturing information about who accessed the server, when the access occurred, what resources were accessed, the nature of the access, or a combination thereof. These events typically include details such as user identity, IP address, time of access, type of operation performed (e.g., read, write, modify), information about resources or files accessed, and etcetera. Such events help in identifying unauthorized access or unusual patterns that could indicate a security threat (see FIG. 3A and corresponding text for further details).

Endpoint detection data refers to information collected from endpoint devices (e.g., endpoints) within a network, such as computers, smartphones, or other connected devices, that are monitored for security threats. This data may include logs and alerts generated by security software installed on these endpoints, capturing details about potential security incidents, malware detections, unauthorized access attempts, and other anomalous activities. Endpoint detection data is used to identify and respond to security threats in real-time, providing insights into the behavior of devices and helping to prevent the spread of malware or unauthorized access within a network (see FIG. 3B and corresponding text for further details).

The labeled dataset allows for the application of supervised classification algorithms, effectively transforming lateral movement detection from an anomaly-based problem into a supervised learning problem (see FIG. 3C and corresponding text for further details). The trained AI model leverages a variety of features, including user behavior, access rarity, machine access patterns, and entity risk scores, to predict whether an access event represents lateral movement. Additionally, by analyzing the AI model's decision-making process, enhanced rules may be developed for identifying lateral movement. This dual functionality enhances the flexibility and effectiveness of the system.

In one embodiment, the present disclosure trains the AI model using a processing device to collect first data (includes a first identifier) that corresponds to an authentication on a first machine in a computer network. In one embodiment, the first machine is a server and the first identifier is a process identifier assigned to a process initiated during the authentication. The processing device also collects second data (includes a second identifier) that corresponds to a malicious event on a second machine in the computer network. In one embodiment, the second machine is an endpoint device and the second identifier is the process identifier assigned to the process initiated during the authentication. In one embodiment, the first data is server access event authentication data that includes a user ID corresponding the authentication, the first time, the process identifier, and a machine identifier corresponding to the first machine. In one embodiment, the second data is endpoint detection data including a second machine identifier corresponding to the second machine, the second time, the process identifier that matches the process identifier, and a detection identifier corresponding to the malicious event.

The processing device then associates the first data with the second data based on the first identifier and the second identifier to produce a labeled dataset corresponding to a traversal through the computer network. In one embodiment, associating the first data with the second data includes correlating a first time corresponding to the first data with a second time corresponding to the second data. In one embodiment, the traversal is a lateral movement through the computer network that includes the first machine and the second machine. In one embodiment, the lateral movement uses a third machine between the first machine and the second machine.

In one embodiment, the processing device enriches the labeled dataset based on an entity risk score derived from at least one of historical access behavior, user role classifications, or a known vulnerability associated with user credentials. For example, the processing device may assess each entity within the computer network against key risk factors. Historical access behavior is analyzed to identify patterns indicative of normal or anomalous activities, providing insights into potential security risks. User role classifications are incorporated to understand the typical permissions and access levels associated with different roles, allowing for the identification of deviations that may signal security concerns. Additionally, known vulnerabilities linked to user credentials, such as weak passwords or exposure in data breaches, may be factored into the risk assessment. This comprehensive risk evaluation assigns an entity risk score to each data point, which may then be appended to the labeled dataset. By integrating these risk scores, the enriched dataset offers a more nuanced view of the computer network's security landscape, enabling the AI models to better differentiate between benign and potentially malicious activities, thereby improving the accuracy and effectiveness of threat detection. The processing device then trains an artificial intelligence (AI) model via supervised learning based on the labeled dataset.

In one embodiment, the processing device extracts a detection rule from the trained AI model to produce a set of human-readable guidelines for enhancing an existing security protocol. For example, detection rules are extracted from the AI model through a process that involves analyzing the AI model's learned patterns and decision-making criteria. Once the AI model has been trained on a heuristically enriched labeled dataset, the AI model develops an understanding of the features and combinations that are indicative of security threats, such as lateral movement within a network. To extract these insights, the processing device uses techniques such as feature importance analysis, decision tree visualization, or rule-based extraction methods to identify which features and thresholds contribute most significantly to the model's predictions. The extracted rules are then translated into human-readable guidelines, providing clear criteria or conditions that can be integrated into existing security protocols. These guidelines help security teams understand the rationale behind the AI model's decisions, allowing them to implement proactive measures, adjust access controls, and refine monitoring strategies to enhance network security. By translating complex model insights into actionable rules, organizations can leverage AI-driven insights to bolster their security frameworks effectively.

In one embodiment, the present disclosure uses the processing device and AI model to monitor resource requests and determine whether to grant access to the resource based on an inference value produced by the AI model. The processing device obtains a request to access a resource in a computer network. The processing device provides the request as an input to the trained AI model, which is trained via supervised learning as discussed herein to produce an inference value that indicates whether the request corresponds to a lateral movement through the computer network. The processing device determines, from the inference value, whether to allow access to the resource, and grants access to the resource based on the determining. In one embodiment, the inference value is a sole factor in the determining whether to allow access to the resource. In other words, the confidence of the AI model inference is high enough to not require additional review and analysis.

In one embodiment, the processing device mines the AI model to identify a lateral detection rule and compares the lateral detection rule to the request. The processing device may initiate a second factor authentication based on comparing the lateral detection rule to the request. In turn, the processing device determines a result of the second factor authentication and grants access to the resource based on the result of the second factor authentication.

In one embodiment, the processing device sends an alert to an administrator of the computer network in response to determining that the request corresponds to the lateral movement through the computer network.

As discussed herein, the present disclosure provides an approach that improves the operation of a computer system by training an AI model trained through supervised learning and using the trained AI model to enhance the accuracy of detecting lateral movements. In addition, the present disclosure provides an improvement to the technological field of cybersecurity by transforming lateral movement detection from an unsupervised analysis into a supervised analysis, allowing for more accurate and reliable detection using AI models trained on labeled data.

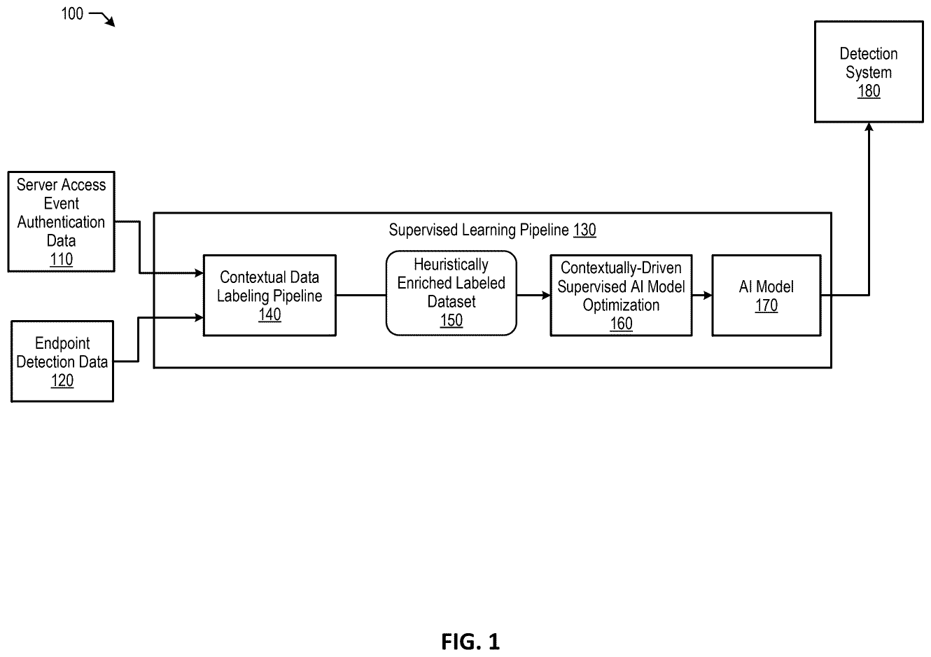

FIG. 1 is a block diagram that illustrates an example system for producing and using a heuristically enriched labeled dataset to train an AI model, in accordance with some embodiments of the present disclosure.

System 100 includes supervised learning pipeline 130, which receives server access event authentication data 110 and endpoint detection data 120. In one embodiment, server access event authentication data 110 is collected from logging systems within a computer network's servers, capturing detailed records of user interactions and activities. Server access event authentication data 110 includes, for example, records of interactions between users or systems and a server, capturing information about who accessed the server, when the access occurred, what resources were accessed, and the nature of the access. These events typically include details such as user identity, IP address, time of access, type of operation performed (e.g., read, write, modify), and resources or files accessed, which help in identifying unauthorized access or unusual patterns that could indicate a security threat. Endpoint detection data 120, in one embodiment, is collected from security software installed on endpoint devices (e.g., computers, smartphones, or other connected devices) that monitor for potential threats and anomalies in real-time. Endpoint detection data 120 includes logs and alerts generated by the security software that capture details about potential security incidents, malware detections, unauthorized access attempts, and other anomalous activities. Endpoint detection data 120 provides insights into the behavior of devices and helps to prevent the spread of malware or unauthorized access within a computer network.

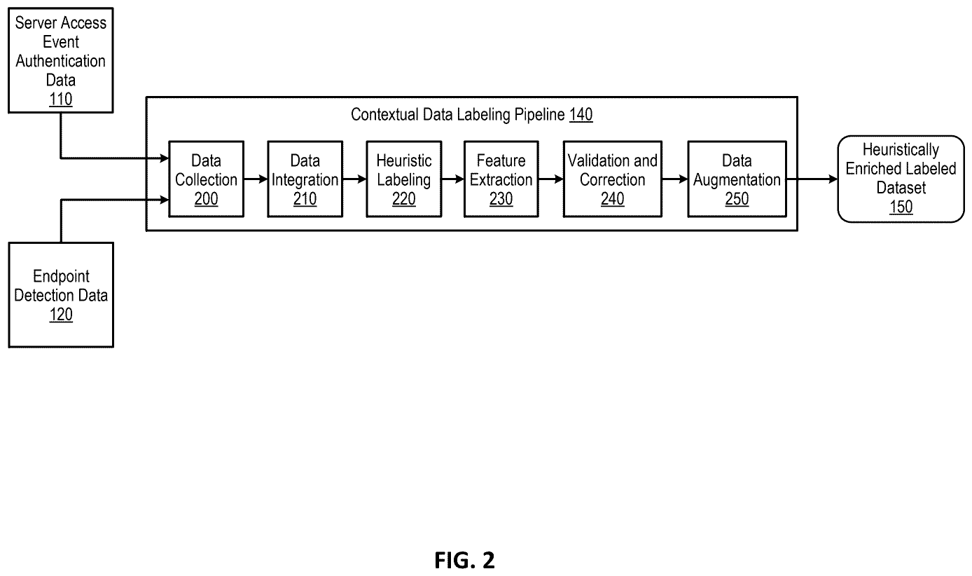

Contextual data labeling pipeline 140 receives server access event authentication data 110 and endpoint detection data 120 to produce heuristically enriched labeled dataset 150. Contextual data labeling pipeline 140 aligns the collected data based on time stamps and user identities to build a comprehensive view of network activity. Contextual data labeling pipeline 140 pipeline applies heuristic rules, developed from domain expertise and historical patterns, to assign labels to each data point that distinguishes between benign and potentially malicious activities. In one embodiment, heuristically enriched labeled dataset 150 is enriched with contextual insights, such as user roles and network topology, providing a robust foundation for training machine learning models to detect lateral movement and other security threats effectively (see FIG. 2 and corresponding text for further details).

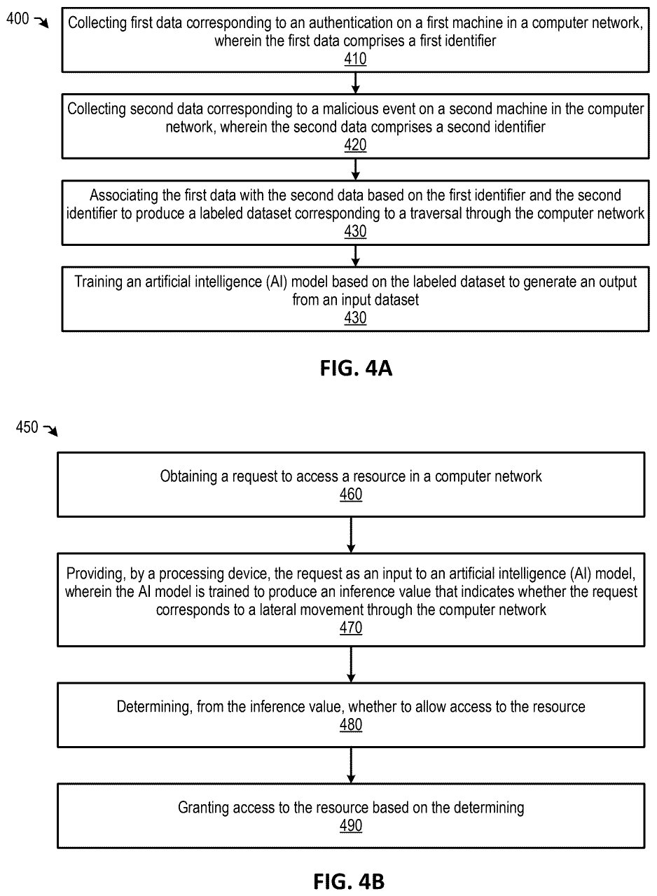

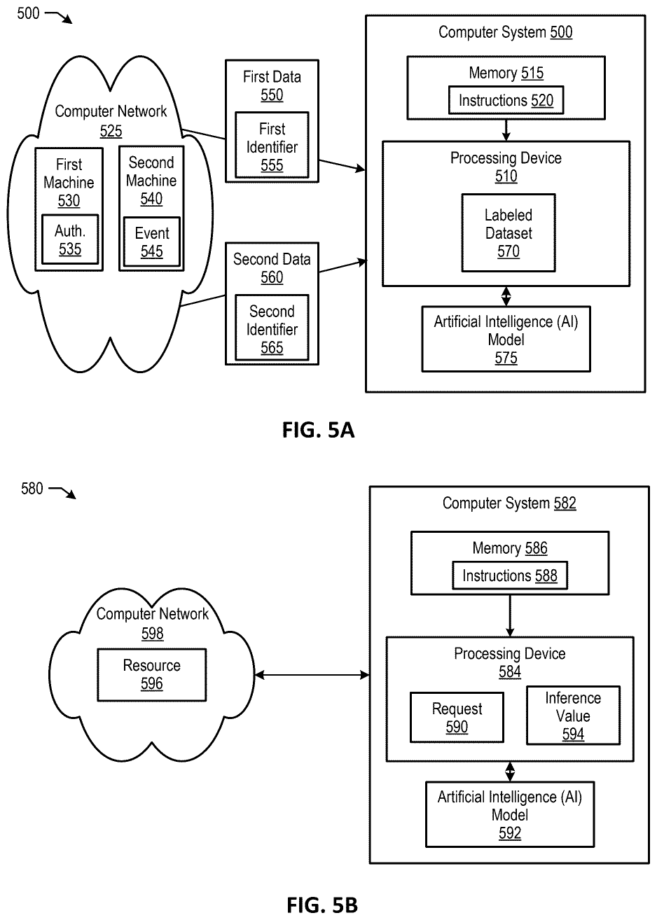

Contextually-driven supervised AI model optimization 160 trains AI model 170 by leveraging rich, contextual data to enhance learning and predictive accuracy. Contextually-driven supervised AI model optimization 160 receives heuristically enriched labeled dataset 150 and applies supervised learning techniques to train AI model 170. Supervised learning techniques involve training an algorithm on a labeled dataset (heuristically enriched labeled dataset 150) to learn the mapping between inputs and outputs, enabling AI model 170 to predict outcomes for new, unseen data accurately. During the optimization phase, AI model 170 undergoes iterative refinement, using techniques such as cross-validation and hyperparameter tuning, to improve its ability to generalize from the training data to unseen scenarios. This approach allows AI model 170 to develop a nuanced understanding of normal versus anomalous behaviors, significantly enhancing its ability to detect lateral movements and other security threats in real-time, with increased precision and reduced false positives. In turn, system 100 deploys AI model 170 to detection system 180 for lateral movement detection in a computer network (see FIGS. 4B, 5B, and corresponding text for further details). Detection system 180 may be, for example, an intrusion detection systems (IDS) that monitors network traffic for suspicious activities, antivirus programs that scan for malware, endpoint detection and response (EDR) solutions that identify and mitigate threats on individual devices, or a combination thereof.

In one embodiment, the trained AI model is employed to detect lateral movements within a computer network by analyzing network traffic data in real-time. The AI model leverages these features to differentiate between normal and potentially malicious activities. By continuously monitoring network traffic, the AI model can identify anomalies that suggest lateral movement, such as unusual access patterns or unauthorized access attempts. Upon detecting a potential lateral movement threat, the AI model generates an alert, which is sent to a network administrator. This alert enables timely intervention to mitigate the threat, thereby enhancing the security of the network. The AI model's ability to transform lateral movement detection from an unsupervised anomaly-based problem into a supervised learning problem significantly improves the accuracy and reliability of threat detection.

In one embodiment, the trained AI model detects lateral movements by leveraging a comprehensive set of features derived from a labeled dataset that correlates server access event authentication data with endpoint detection data. This dataset includes detailed records of user interactions, such as user identity, IP address, time of access, and the nature of the access, as well as endpoint detection logs that capture potential security incidents and anomalies. By training the AI model through supervised learning, it gains the ability to recognize complex patterns and subtle deviations from normal behavior that are indicative of lateral movement. Unlike traditional systems that rely on anomaly detection, which often results in high false-positive rates due to the lack of labeled data, the supervised learning approach provides the AI model with a solid foundation of known malicious and benign examples. This allows the model to make more accurate predictions and reduce false alarms. The AI model's ability to continuously learn and adapt to new patterns further enhances its effectiveness, making it superior to existing systems that may struggle to generalize beyond predefined rules or historical baselines. As a result, the AI model offers a more precise and reliable method for detecting lateral movements, improving the overall security posture of the network.

FIG. 2 is a block diagram that illustrates an example contextual data labeling pipeline, in accordance with some embodiments of the present disclosure. Contextual data labeling pipeline 140 produces heuristically enriched labeled dataset 150 through a process that leverages heuristic approaches to enhance the labeling of data points with rich contextual information.

Contextual data labeling pipeline 140 uses data collection 200 to collect server access event authentication data 110 and endpoint detection data 120 as discussed herein. Data integration 210 combines server access event authentication data 110 and endpoint detection data 120 to produce a comprehensive dataset. Data integration 210 involves aligning data points based various factors such as time, process identifier, etc. to ensure that the server access event authentication data and endpoint detection data are accurately associated.

Heuristic labeling 220 develops heuristic rules to automatically label data points. For example, if server access event authentication data 110 coincides with a high-confidence endpoint detection alert (such as a known malware signature), it is labeled as “malicious.” Conversely, if no such detection is associated with an access event, it is labeled as “benign” (see FIGS. 3A, 3B, 3C, and corresponding text for further details). Heuristic labeling 220 uses domain knowledge to refine these heuristics, taking into account the typical behavior patterns within the network and known security threats. For example, consider a corporate network where employees typically log into their systems between 8 AM and 6 PM. Heuristic labeling 220 may be designed to label login attempts outside of these hours as “suspicious,” especially if the login originates from an unusual IP address or location. Additionally, if an employee in the finance department suddenly accesses a high-security server typically reserved for IT administrators, heuristic labeling 220 could flag the event as “potentially malicious.” In one embodiment, heuristic labeling 220 applies domain knowledge by incorporating known security threats and behavior patterns. For example, if the computer network has experienced phishing attacks where compromised credentials were used to access sensitive systems, heuristic labeling 220 can adjust labeling to give higher suspicion to access attempts following known phishing campaigns. Likewise, if a particular server has been the target of previous attacks, any access to it might be labeled with higher scrutiny, especially if it deviates from established patterns. By continuously updating these heuristics based on new threats and observed network behaviors, heuristic labeling 220 becomes more accurate, reducing false positives while enhancing the detection of genuine security threats. In one embodiment, heuristic labeling 220 leverages practical rules derived from domain expertise to label events without requiring exhaustive manual annotation. By using endpoint detection alerts as a proxy for malicious activity, heuristic labeling 220 circumvents the need for large, manually labeled datasets, which are often impractical to obtain.

Feature extraction 230 extracts relevant features from the combined dataset that will be useful for model training. For server access event authentication data, features might include the frequency of access by a user, the types of resources accessed, and deviations from normal access patterns. For endpoint detection data, features could include types of detected threats, anomaly scores, and the number of failed access attempts. In one embodiment, feature extraction 230 combines elements from both server access and endpoint detection data. This includes not only traditional features such as access frequency and threat types but also novel combinations such as deviations from standard user behavior patterns and cross-referencing with historical access data. This comprehensive feature set enhances AI model 170's ability to detect subtle signs of lateral movement that might otherwise be missed.

Validation and correction 240 reviews the labeled data to ensure accuracy, which may involve security experts verifying the heuristic labels against known incidents to correct any mislabeling. Validation and correction 240 iterates on the heuristic rules based on feedback from this review to improve the accuracy of automatic labeling.

Data augmentation 250 enhances the dataset by including additional contextual information, such as user roles, network topology, or historical access patterns, to provide richer data for AI model training. In one embodiment, by enriching the data with user roles, network topology, and historical patterns, data augmentation 250 provides a richer context for AI model training, which enhances detection capabilities. This contextual augmentation allows the AI model 170 to understand not just the “what” of an event, but the “why,” improving its predictive power.

FIG. 3A is a diagram that illustrates an example table of server access event authentication data, in accordance with some embodiments of the present disclosure. Table 300 includes three machine authentication events. Column 305 includes user IDs corresponding to the user requesting authentication and column 310 includes the corresponding authentication time. Column 315 includes user process IDs, which are unique numbers assigned by an operating system to each active process, allowing the system to manage and track the execution of applications and tasks. Column 320 includes machine IDs, which are unique codes or labels assigned to a computer or device within a computer network used to distinguish it from other machines and track its activity for security, management, and operational purposes. Table 300 may include more or less columns than what is shown in FIG. 3A.

FIG. 3B is a diagram that illustrates an example table that includes endpoint detection data (e.g., endpoint detection log data), in accordance with some embodiments of the present disclosure. Table 325 includes detection events identified by, for example, a security agent system. Table 325 includes some columns similar to table 300 shown in FIG. 3A. Column 330 includes machine IDs and column 335 includes detection times. The detection times correspond to times at which an event was detected (e.g., memory dump). Column 340 includes user process IDs, which correlates to the process IDs shown in column 315 of table 300. Column 345 includes detection name IDs, which are unique identifiers assigned to a type of security threat or anomaly detected by a security system, allowing for efficient categorization and tracking of the threat across various systems and reports. Table 325 may include more or less columns than what is shown in FIG. 3B.

FIG. 3C is a diagram that illustrates an example of a labeled dataset, in accordance with some embodiments of the present disclosure.

Table 350 includes three entries 355, 360, and 365. Table 350 shows a paring of the server access event authentication data in table 300 with event detection data in table 325. Column 370 includes the corresponding user ID of an authenticating user. Column 375 includes the corresponding time at which the user authenticated. Column 380 includes a user process ID assigned to the corresponding process on the machine to which the user authenticated. Column 385 includes the machine ID of the machine to which the user was authenticated.

Column 390 includes the detection name ID (if applicable) related to the process spawned by the authenticated user. Entry 360 includes a detection name ID, indicating that the entry corresponds to a malicious event, and entries 355 and 365 do not include a detection name ID, indicating that the entries do not correspond to a malicious event. Column 395 includes a binary label for the training labeled dataset. The binary label is equal to 1 when a user authenticated and the process which they spawned resulted in a detection (entry 360), otherwise the label is zero (entries 355 and 365).

FIG. 4A is a flow diagram of a method 400 for generating a labeled dataset and training an AI model via supervised learning using the labeled dataset, in accordance with some embodiments of the present disclosure.

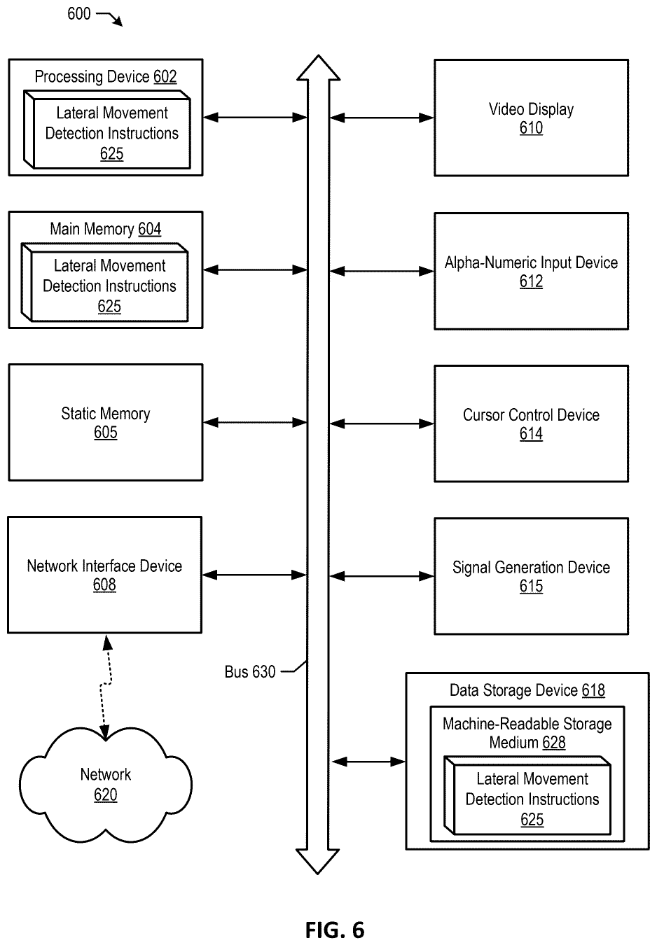

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by supervised learning pipeline 130 (shown in FIG. 1), processing device 510 (shown in FIG. 5A), processing device 602 (shown in FIG. 6), or a combination thereof.

With reference to FIG. 4A, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4A, method 400 begins at block 410, whereupon processing logic collects first data, which includes a first identifier, and corresponds to an authentication on a first machine in a computer network. In one embodiment, the first machine is a server and the first identifier is a process identifier assigned to a process initiated during the authentication. In one embodiment, the first data is server access event authentication data including a user ID corresponding the authentication, the first time, the process identifier, and a machine identifier corresponding to the first machine.

At block 420, processing logic collects second data, which includes a second identifier, and corresponds to a malicious event on a second machine in the computer network. In one embodiment, the second machine is an endpoint device and the second identifier is the process identifier assigned to the process initiated during the authentication. In one embodiment, the second data is endpoint detection data including a second machine identifier corresponding to the second machine, the second time, the process identifier that matches the process identifier, and a detection identifier corresponding to the malicious event.

At block 430, processing logic associates the first data with the second data based on the first identifier and the second identifier to produce a labeled dataset corresponding to a traversal through the computer network. In one embodiment, the associating the first data with the second data includes correlating a first time corresponding to the first data with a second time corresponding to the second data. In one embodiment, the traversal is a lateral movement through the computer network including the first machine and the second machine. In one embodiment, the lateral movement includes a third machine between the first machine and the second machine. In one embodiment, processing logic enriches the labeled dataset based on an entity risk score derived from at least one of historical access behavior, user role classifications, or a known vulnerability associated with user credentials.

At block 440, processing logic trains an artificial intelligence (AI) model based on the labeled dataset to generate an output from an input dataset. In one embodiment, processing logic then utilizes the trained AI model to analyze network traffic from the computer network to detect a potential lateral movement threat and send an alert to an administrator of the potential lateral movement threat. In one embodiment, processing logic extracts a detection rule from the trained AI model produces a set of human-readable guidelines for enhancing an existing security protocol.

FIG. 4B is a flow diagram of a method 450 for using a trained AI model to detect lateral movement in a computer network, in accordance with some embodiments of the present disclosure.

Method 450 may be performed by processing logic that may include hardware (e.g., a processing device), software (e.g., instructions running/executing on a processing device), firmware (e.g., microcode), or a combination thereof. In some embodiments, at least a portion of method 450 may be performed by supervised learning pipeline 130 (shown in FIG. 1), processing device 584 (shown in FIG. 5B), processing device 602 (shown in FIG. 6), or a combination thereof.

With reference to FIG. 4B, method 450 illustrates example functions used by various embodiments. Although specific function blocks (“blocks”) are disclosed in method 450, such blocks are examples. That is, embodiments are well suited to performing various other blocks or variations of the blocks recited in method 400. It is appreciated that the blocks in method 450 may be performed in an order different than presented, and that not all of the blocks in method 450 may be performed.

With reference to FIG. 4B, method 450 begins at block 460, whereupon processing logic obtains a request to access a resource in a computer network. At block 470, processing logic provides the request as an input to an artificial intelligence (AI) model, wherein the AI model is trained to produce an inference value that indicates whether the request corresponds to a lateral movement through the computer network.

At block 480, processing logic determines, from the inference value, whether to allow access to the resource. In one embodiment, the inference value is a sole factor in the determining whether to allow access to the resource. At block 490, processing logic grants access to the resource based on the determining.

In one embodiment, processing logic mines the AI model to identify a lateral detection rule and compares the lateral detection rule to the request. In one embodiment, processing logic initiates a second factor authentication based on the comparing the lateral detection rule to the request. Processing logic then determines a result of the second factor authentication, and grants access to the resource based on the result of the second factor authentication.

In one embodiment, processing logic produces a labeled dataset using first data corresponding to an authentication on a first machine in a computer network and second data corresponding to a malicious event on a second machine in the computer network. Processing logic then trains the AI model via supervised learning using the labeled dataset. In one embodiment, the labeled dataset correlates server access event authentication data with endpoint detection data to identify patterns indicative of the lateral movement. In one embodiment, processing logic sends an alert to an administrator of the computer network in response to determining that the request corresponds to the lateral movement through the computer network.

FIG. 5A is a block diagram that illustrates an example system for lateral movement detection training of an AI model using a labeled dataset, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to collect first data 550, which includes first identifier 555, and corresponds to an authentication 535 on a first machine 530 in a computer network 525. Processing device then collects second data 560, which includes second identifier 565, and corresponds to a malicious event 545 on a second machine 540 in the computer network 525.

Processing device 510 associates the first data 550 with the second data 560 based on the first identifier 555 and the second identifier 565 to produce a labeled dataset 570 corresponding to a traversal through the computer network 525. In turn, processing device 510 trains artificial intelligence (AI) model 575 based on the labeled dataset 570 to generate an output from an input dataset. In one embodiment, processing device 510 then utilizes the trained AI model 575 to analyze network traffic from the computer network 525 to detect a potential lateral movement threat and send an alert to an administrator of the potential lateral movement threat.

FIG. 5B is a block diagram that illustrates an example system for using a trained AI model to detect lateral movement in a computer network, in accordance with some embodiments of the present disclosure.

Computer system 582 includes processing device 584 and memory 586. Memory 586 stores instructions 588 that are executed by processing device 584. Instructions 588, when executed by processing device 584, cause processing device 584 to obtain a request 590 to access a resource 596 in a computer network 598. Processing device 584 provides the request 590 as an input to artificial intelligence (AI) model 592, which is trained to produce an inference value 594 that indicates whether the request corresponds to a lateral movement through the computer network. Processing device 584 determines, from the inference value, whether to allow access to the resource 596. In turn, processing device 584 grants access to the resource based on the determining.

FIG. 6 illustrates a diagrammatic representation of a machine in the example form of a computer system 600 within which a set of instructions, for causing the machine to perform any one or more of the methodologies discussed herein for lateral movement detection training.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing system 600 may further include a network interface device 608 which may communicate with a network 620. The computing system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute lateral movement detection instructions 625, for performing the operations and steps discussed herein.

The data storage device 618 may include a machine-readable storage medium 628, on which is stored one or more sets of lateral movement detection instructions 625 (e.g., software) embodying any one or more of the methodologies of functions described herein. The lateral movement detection instructions 625 may also reside, completely or at least partially, within the main memory 604 or within the processing device 602 during execution thereof by the computer system 600; the main memory 604 and the processing device 602 also constituting machine-readable storage media. The lateral movement detection instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “collecting,” “associating,” “training,” “extracting,” “producing,” “analyzing,” “sending,” “enriching,” “obtaining,” “providing,” “determining,” “granting,” “mining,” “comparing,” “initiating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
obtaining a request to access a resource in a computer network;
providing, by a processing device, the request as an input to an artificial intelligence (AI) model, wherein the AI model is trained to produce an inference value that indicates whether the request corresponds to a lateral movement through the computer network;
determining, from the inference value, whether to allow access to the resource; and
granting access to the resource based on the determining.

2. The method of claim 1, wherein the determining further comprises:
mining the AI model to identify a lateral detection rule; and
comparing the lateral detection rule to the request.

3. The method of claim 2, further comprising:
initiating a second factor authentication based on the comparing the lateral detection rule to the request;
determining a result of the second factor authentication; and
granting the access to the resource based on the result of the second factor authentication.

4. The method of claim 1, further comprising:
producing a labeled dataset using first data corresponding to an authentication on a first machine in a computer network and second data corresponding to a malicious event on a second machine in the computer network; and
training the AI model via supervised learning using the labeled dataset.

5. The method of claim 4, wherein the labeled dataset correlates server access event authentication data with endpoint detection data to identify patterns indicative of the lateral movement.

6. The method of claim 1, further comprising:
sending an alert to an administrator of the computer network in response to determining that the request corresponds to the lateral movement through the computer network.

7. The method of claim 1, wherein the inference value is a sole factor in the determining whether to allow access to the resource.

8. A method comprising:
collecting first data corresponding to an authentication on a first machine in a computer network, wherein the first data comprises a first identifier;
collecting second data corresponding to a malicious event on a second machine in the computer network, wherein the second data comprises a second identifier;
associating, by a processing device, the first data with the second data based on the first identifier and the second identifier to produce a labeled dataset corresponding to a traversal through the computer network; and
training an artificial intelligence (AI) model based on the labeled dataset to generate an output from an input dataset.

9. The method of claim 8, wherein the associating the first data with the second data further comprises correlating a first time corresponding to the first data with a second time corresponding to the second data.

10. The method of claim 9, wherein
the first machine is a server and the first identifier is a process identifier assigned to a process initiated during the authentication; and
the second machine is an endpoint device and the second identifier is the process identifier assigned to the process initiated during the authentication.

11. The method of claim 10, wherein
the first data is server access event authentication data comprising a user ID corresponding the authentication, the first time, the process identifier, and a machine identifier corresponding to the first machine; and
the second data is endpoint detection data comprising a second machine identifier corresponding to the second machine, the second time, the process identifier that matches the process identifier, and a detection identifier corresponding to the malicious event.

12. The method of claim 8, further comprising:
extracting a detection rule from the AI model that is trained; and
producing, from the detection rule, a set of human-readable guidelines for enhancing an existing security protocol.

13. The method of claim 8, further comprising:
analyzing, by the AI model, network traffic from the computer network to detect a potential lateral movement threat; and
sending an alert to an administrator of the potential lateral movement threat.

14. The method of claim 8, wherein the traversal is a lateral movement through the computer network comprising the first machine and the second machine.

15. The method of claim 14, wherein the lateral movement comprises a third machine between the first machine and the second machine.

16. The method of claim 8, further comprising:
enriching the labeled dataset based on an entity risk score derived from at least one of historical access behavior, user role classifications, or a known vulnerability associated with user credentials.

17. A system comprising:
a memory; and
a processing device, operatively coupled to the memory, to:
obtain a request to access a resource in a computer network;
provide the request as an input to an artificial intelligence (AI) model, wherein the AI model is trained to produce an inference value that indicates whether the request corresponds to a lateral movement through the computer network;
determine, from the inference value, whether to allow access to the resource; and
grant access to the resource based on the determining.

18. The system of claim 17, wherein the processing device is further to:
mine the AI model to identify a lateral detection rule;
compare the lateral detection rule to the request;
initiate a second factor authentication based on the comparing the lateral detection rule to the request;
determine a result of the second factor authentication; and
grant the access to the resource based on the result of the second factor authentication.

19. The system of claim 17, wherein the processing device is further to:
produce a labeled dataset using first data corresponding to an authentication on a first machine in a computer network and second data corresponding to a malicious event on a second machine in the computer network; and
train the AI model via supervised learning using the labeled dataset.

20. The system of claim 17, wherein the processing device is further to:
send an alert to an administrator of the computer network in response to determining that the request corresponds to the lateral movement through the computer network.
